(19) United States
(12) Patent Application Publication
(10) Pub. No.: US 2009/0133592 A1
(43) Pub. Date: May 28, 2009

(54) Stop Block for Stamping Presses

(75) Inventor: John Carlson, Fenton, MI (US)

Correspondence Address: BROOKS KUSHMAN P.C., 1000 TOWN CENTER, TWENTY-SECOND FLOOR, SOUTHFIELD, MI, 48075, US

(73) Assignee: E & E MANUFACTURING COMPANY, INC., Plymouth, MI (US)

(21) Appl. No.: 12/277,657

(22) Filed: Nov. 25, 2008

Related U.S. Application Data
(60) Provisional application No. 61/004,269, filed on Nov. 26, 2007.

(51) Int. Cl. F16P 1/00

(52) U.S. Cl. 100/350

(57) ABSTRACT

A lock-out assembly for a heavy duty workpiece-forming press comprising an elongated stop lock assembly pivoted on a press bolster for arcuate movement by an operator into and out of a path of movement of a press ram whereby operator safety is assured as the operator assembles a die set and a workpiece on the bolster and when the operator removes a finished formed workpiece.

### CROSS-REFERENCE TO RELATED APPLICATIONS

This application claims the benefit of U.S. provisional application Ser. No. 61/004,269 filed Nov. 26, 2007.

### BACKGROUND OF THE INVENTION

1. Field of the Invention

The invention relates to stamping presses, particularly heavy tonnage presses having a stationary bolster and a vertically movable ram wherein the bolster and the ram support forming dies of a die set.

2. Background Art

A typical stamping press has a movable ram that is powered by an electrical power source or a pneumatic power source. The ram moves a die into registry with a companion die supported by a bolster and then is retracted to permit the workpiece to be removed or to permit replacement dies to be inserted in place for a subsequent stamping operation. This requires human intervention, which presents safety problems if a malfunction should occur in a controller for the dies.

It is typical practice for a press operator at a stamping facility, when the ram is retracted from the bolster following formation of a workpiece, to position a stop block between the die and the bolster as a replacement die set is placed in a fixture on the bolster and on the movable ram of the stamping press. The repeated positioning of the stop block and its removal is part of the operating procedure that must be followed during operation of a stamping press. This puts a strain on the operator since the stop block itself typically is heavy. Further, the entry of the stop block into a path of movement of the ram in the space between the die and the bolster during assembly of the die set and during removal of the workpiece requires an interval of production “down-time” that increases the total cycle time for forming workpieces and lowers production efficiency. It also is standard practice to interrupt power delivery from a power source to the movable ram when the ram is lifted to its inactive position. This requires a disconnection of plugs or connectors and cables to interrupt power delivery from the power source, which further results in production efficiency.

### SUMMARY OF EMBODIMENTS OF THE INVENTION

The invention, according to one embodiment, comprises a pivoting stop block that does not require a stamping press operator to lift the stop block from its stand-by location into the space between the bolster and the movable ram following a forming step for a workpiece. Rather, the stop block is pivoted on the bolster and the operator merely needs to rotate it into position between the ram and the bolster. The stop block may be readily pivoted out of the space between the bolster when the ram is lifted. The stop block, according to a feature of the present invention, engages two portions of a press, which are part of the ram and the bolster. The bolster is stationary, while the ram moves vertically. The bolster holds the lower half of the die set.

When the press is in the open position, power is disconnected by a lock out switch in a ram motor circuit that includes an electric power relay. The lock out switch will cause power to be cut off from the movable ram when the stop block is in a vertical position. Power can only be returned when the switch again is closed. The switch is closed and opened as the stop block is pivoted by the operator, respectively, out of and into its vertical position. A separate press-operating step is not needed to control the switch. During the time that the power is removed from the ram, the press operator can manually adjust the effective length of the stop block so that it will be in a proper position to stop the ram if there is a malfunction in the stamping press control that would result in release of the ram when the operator is working in the path of travel of the ram.

In an alternative embodiment, a pneumatic motor or an electric motor, for example, can be used by the press operator to quickly adjust a threaded portion of the stop block to its proper height. This will eliminate one further manual operation normally performed by the operator. When the operator completes tasks that must be performed when the press is inactive, the stop block is returned to its inactive open position and power is returned to the movable ram as the switch closes. This is done as operator safety is assured.

### BRIEF DESCRIPTION OF THE DRAWINGS

FIG. 1 is an assembly view of a lower portion of a stamping press wherein the stop block assembly is pivoted to an inactive position;

FIG. 2 is a view of the stamping press with the stop block assembly of the present invention in an inactive position as viewed from a side opposite to the side shown in FIG. 1;

FIG. 3 is a cut-away view of a threaded bolt for adjustment of the length of the stop block assembly of the present invention;

FIG. 4 is an overall view of a stamping press with the stop block assembly located in place in a position that will block movement of the ram;

FIG. 5 is a detailed assembly view of the attachment of the ram to the upper portion of the stop block assembly of the invention;

FIG. 6 is a view of the stop block assembly of the invention wherein an adjustment screw is extended so that it engages the ram, the adjustment of the screw being accomplished by a pneumatic or electric motor;

FIG. 7 is a detailed view of a pivotal connection between the stop block assembly and the bolster of the stamping press;

FIG. 7A is a detailed view of the upper portion of the stop block assembly of the invention, which is attached to the movable ram;

FIG. 7 is a side view of the assembly seen in FIG. 7;

FIG. 8A is a view of the top of the stop block assembly of the invention and its connection to the movable ram, which complements the isometric view of FIG. 7A;

FIG. 9 is a diagrammatic exploded view of the mounting structure for pivotally connecting the stop block assembly of the invention to the bolster, together with a control rod with telescopically related components that move relative to each other as the stop block assembly is pivoted about its pivot axis;

FIG. 10 is a view of the stop block assembly seen in FIG. 9 showing in an exploded view the components of the stop block assembly including its pivotal attachment to the bolster and a pneumatic motor for adjusting the threaded screw at one end of the stop block;

FIG. 11 is another exploded view showing the entire assembly comprising a stop block assembly pivotal portion, the attachment elements on the bolster and the attachment elements on the movable ram;

FIG. 12 is an isometric exploded view of the connection of the upper portion of the adjustable stop block assembly with the movable ram;

FIG. 13 is an overall assembly view of the stop block assembly of the present invention as seen in an upright position where it blocks movement of the ram relative to the bolster;

FIG. 14 is a view similar to FIG. 13, but it is viewed from a different perspective than the view of FIG. 13;

FIG. 15 is a view similar to FIG. 14, although it shows the stop block complete assembly from a side opposite to the side seen in FIG. 14;

FIG. 16 is a detailed view of the lower portion of the stop block assembly seen in FIG. 15, although the view of FIG. 16 shows a side different than the side seen in FIG. 15; and

FIG. 17 is a side view of a complete stop block assembly wherein its arcuate movement is illustrated.

### PARTICULAR DESCRIPTION OF THE INVENTION

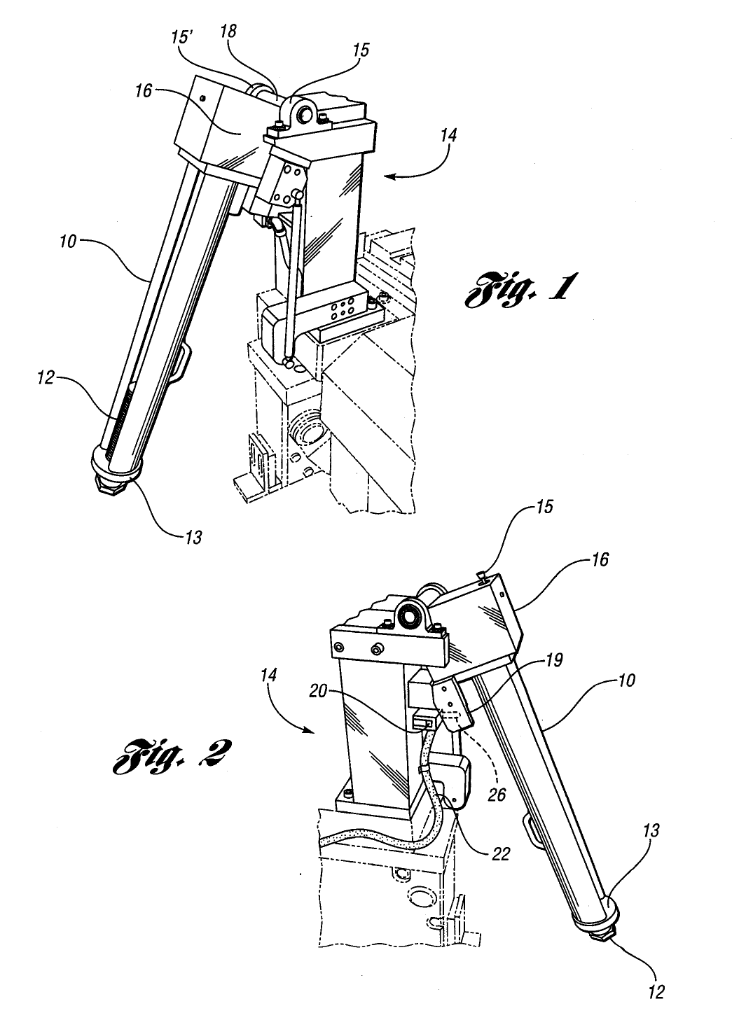

FIG. 1 shows an embodiment of the invention wherein the stop block assembly is an inactive position. A pivotal portion of the stop block assembly is shown at 10. The lower portion of the assembly carries a threaded member 12 received in an internally threaded end piece 13. The bolster of the stamping press is seen at 14. The base portion of the stop block assembly that is pivoted to the bolster is shown at 16. The pivot axis is the axis of pivot shaft 18, which is end supported in bearing structure formed on the bolster 14 as shown at 15 and 15′.

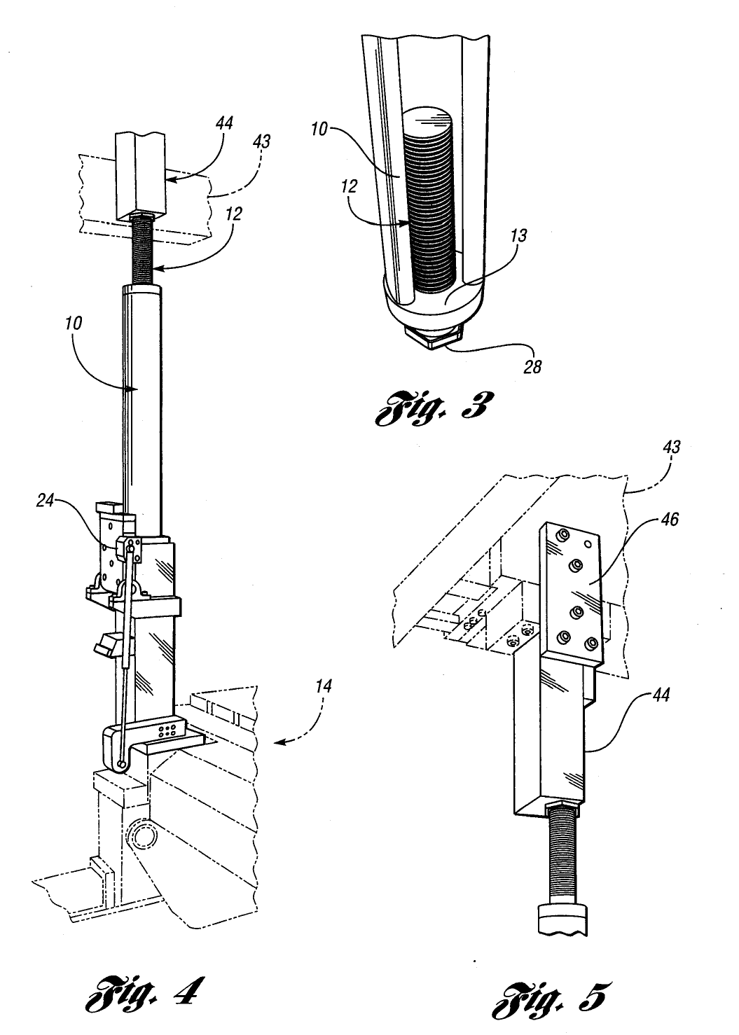

FIG. 2 shows the movable portion of the stop block assembly seen at 10. The portion 16 includes a switch actuator 19 which activates and deactivates a lock out switch 20, whereby power for an electric ram motor that operates the movable ram can be supplied and interrupted. Power can be supplied to the ram through an electric cable.

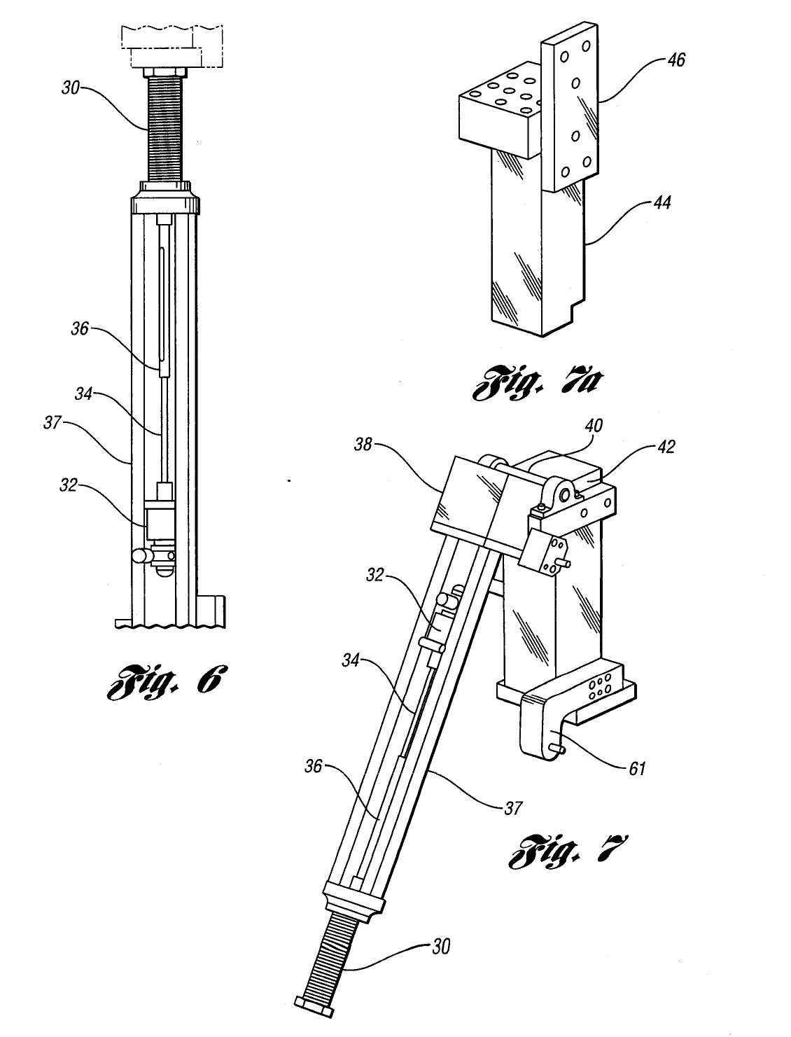

FIG. 4 shows the movable portion 10 of the stop block assembly and its connection to the bolster. The bolster connection includes a bolster plate 24 for pivoting the portion 16 to the bolster. The lock out switch 20 is activated by a lock out trigger or key, seen at 26 on switch actuator 19.

FIG. 3 shows the threaded adjustment member 12 in more detail. It is threadably received in a threaded opening in the end piece 13 of the movable portion 10 of the stop block assembly. The portion of the stop block assembly that would engage the movable ram is seen in FIG. 3 at 28.

FIG. 4 shows the movable portion 10 of the stop block assembly and the modification to the ram, as seen at 43. The lower portion of the stop block assembly is attached to the bolster 14, as described with reference to FIGS. 1 and 3.

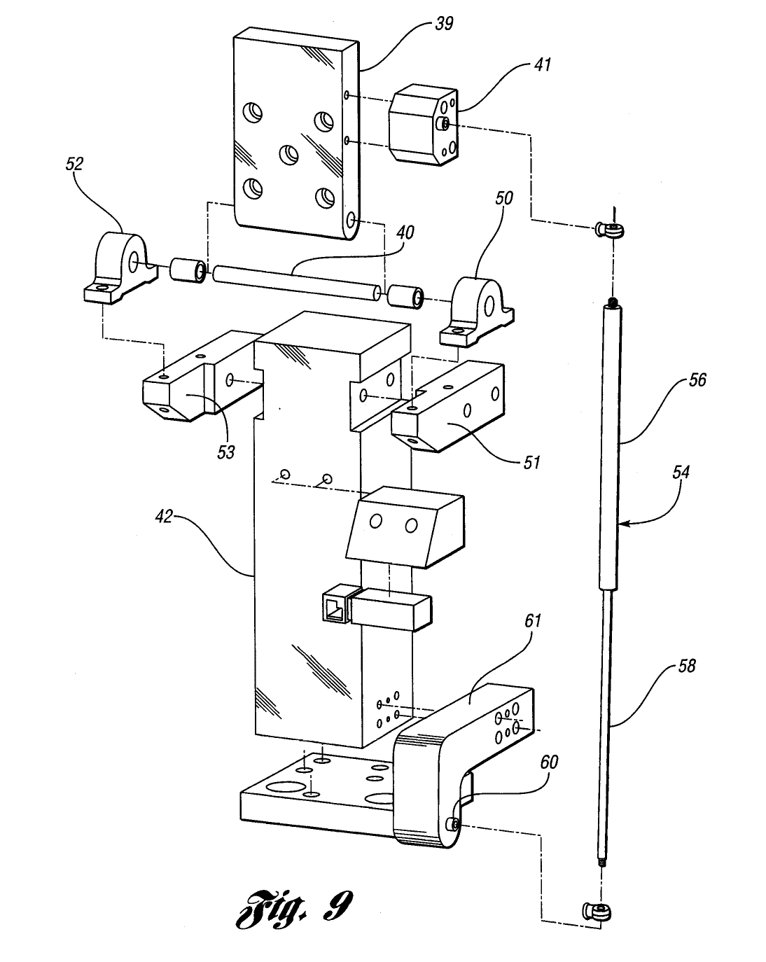

The ram modification described with reference to FIG. 4 is seen in more detail in FIGS. 5 and 7a. It includes a plate 46, which provides a bolted attachment between the ram modification 44 and the ram 43.

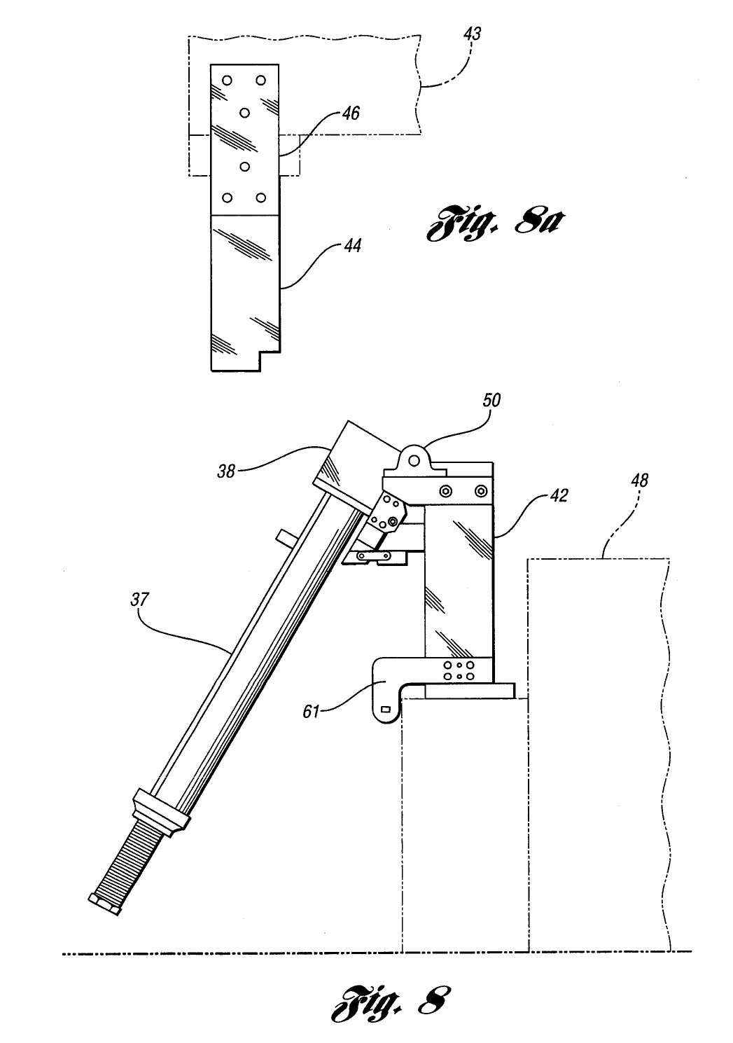

FIG. 6 is a partial assembly view of a modified stop block assembly that includes an automatic adjustment feature for a threaded adjustment member, shown at 30. The stop block assembly of the modification of the present invention with the adjustment screw 30, which corresponds to the adjustment screw 12 seen in FIG. 4, is extended and retracted by a pneumatic motor, or electric motor, as seen at 32. A driven shaft of the motor 32 drives an adjustment rod portion 34, which is received in a slotted rod portion 36. In the view of FIG. 6, the upper end of the portion 36 is drivably connected to the threaded adjustment screw. The rod portion 34 is drivably connected to portion 36 by a pin and slot connection, which accommodates movement of the threaded member 30 when motor 32 rotates rod portion 34.

FIG. 7 shows the stop block assembly, seen in FIG. 6, in its inactive position. The movable portion of the stop block assembly, seen in FIG. 7, is shown at 37, which corresponds to the movable portion 10 in the embodiment of FIGS. 1-5. The pneumatic motor and the threaded adjustment rod can be located within and secured to the movable portion 37.

The portion 38 of the stop block assembly seen in FIG. 7 is pivoted, as shown at 40, to stationary bolster portion 42. The upper portion of the stop block assembly is secured by a plate 46, seen in FIG. 7a, and bolts that extend through the plate 46 to the movable ram modification 44. This ram modification is seen also in FIG. 8a from a different perspective.

FIG. 8 is a view similar to FIG. 7, although it shows the stop block assembly in a side view rather than in the isometric view, as seen in FIG. 7. An illustration of the position of the bolster is seen in FIG. 8 at 48.

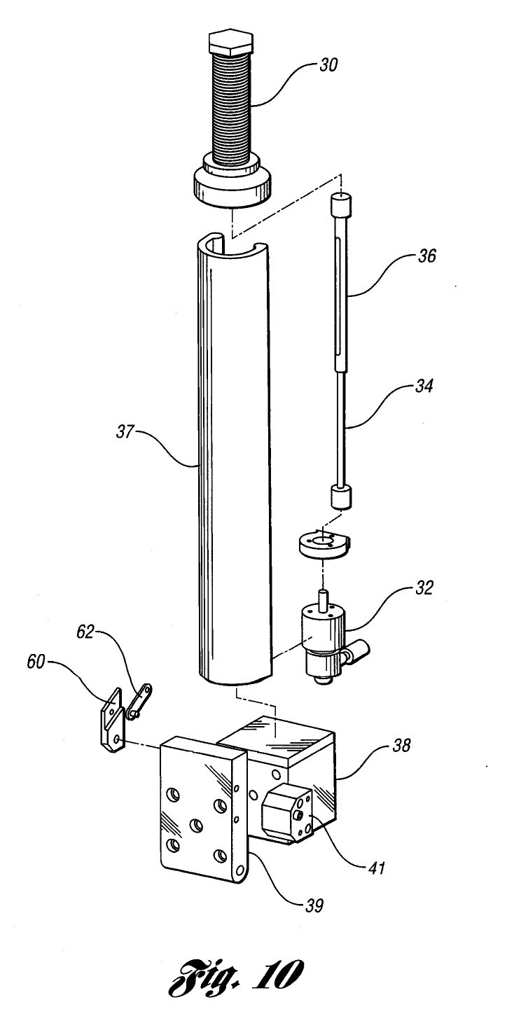

FIG. 9 is an exploded isometric view of the connection of the stop block assembly to the bolster. The pivot shaft 40 is received in an opening in plate 39, which is bolted to portion 38 of the stop block assembly. The movable portion 37 thus is supported by end supports 50 and 52, which are secured to the bolster portion 42 by support elements 51 and 53. A control rod 54 for controlling arcuate movement of the stop block assembly includes telescoping members 56 and 58, which act as an air spring or pneumatic damper. One end of the portion 58 is secured, as shown at 60, to bracket 61, which is bolted to bolster portion 42. One end of the member 56 is secured to the plate 39 by attachment 41. As the plate 38 is pivoted about the pivot shaft 40, telescoping relative movement of the portions 56 and 58 will occur, whereby a “soft landing” of the movable portion 37 is achieved at each end of its arcuate movement.

FIG. 10 is a partial exploded assembly view of the stop block assembly, including portion 37, the rod 34 and the slotted portion 36, which deliver driving torque from motor 32 to adjustable screw 30.

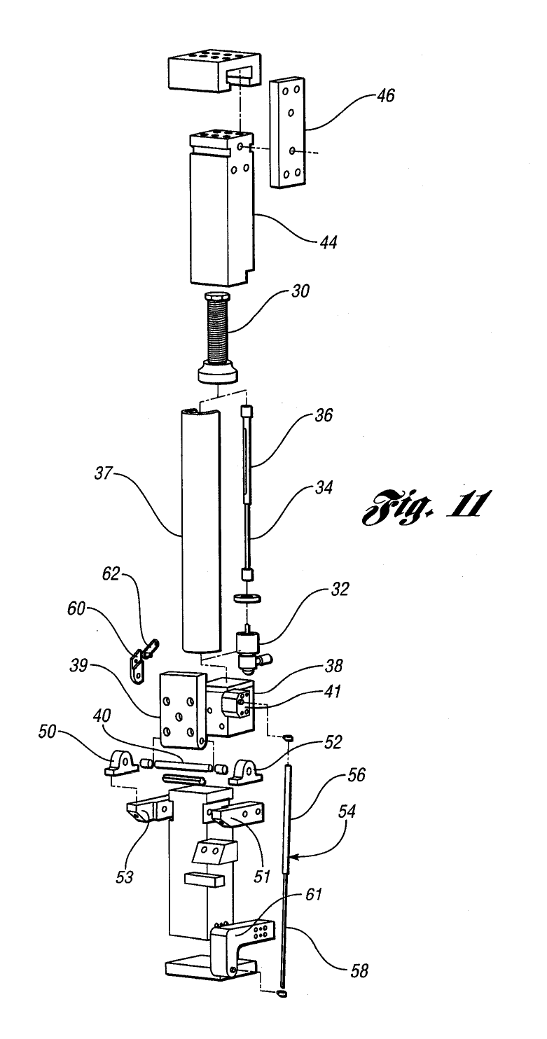

FIG. 11 is a combined exploded view of the elements illustrated in FIGS. 9 and 10.

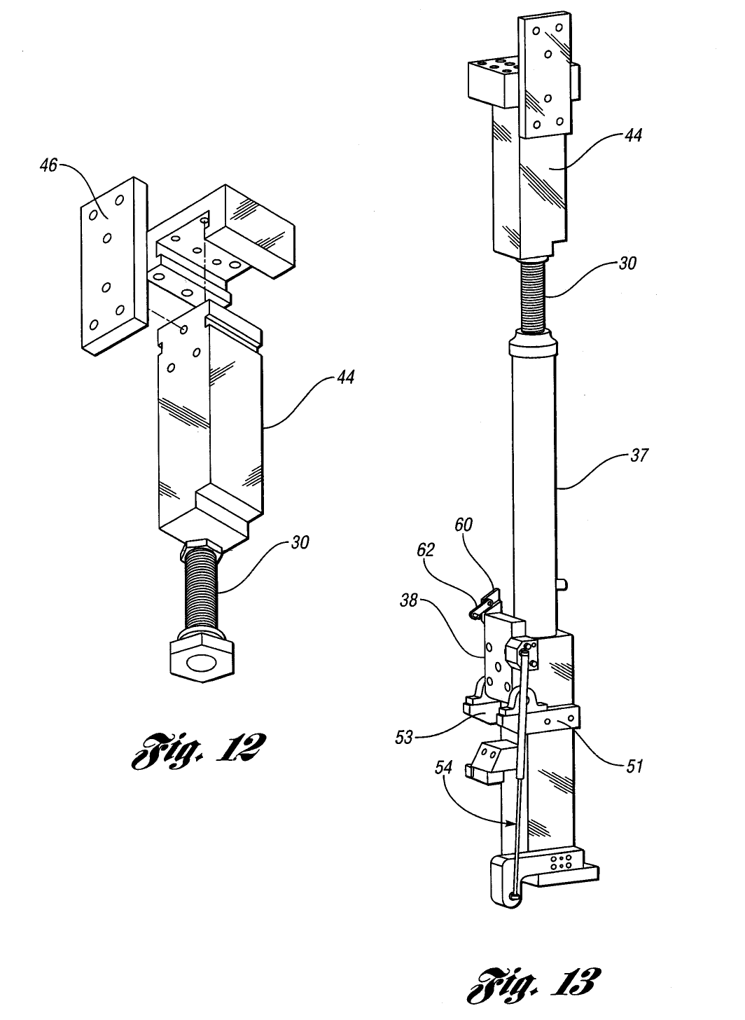

FIG. 12 is an enlargement of the ram modification seen in an exploded view of FIG. 12, which engages the adjustable screw 30 of the stop block assembly of the invention;

FIG. 13 is an overall side elevation view of the stop block assembly, which includes the elements illustrated in exploded form in the view of FIG. 11.

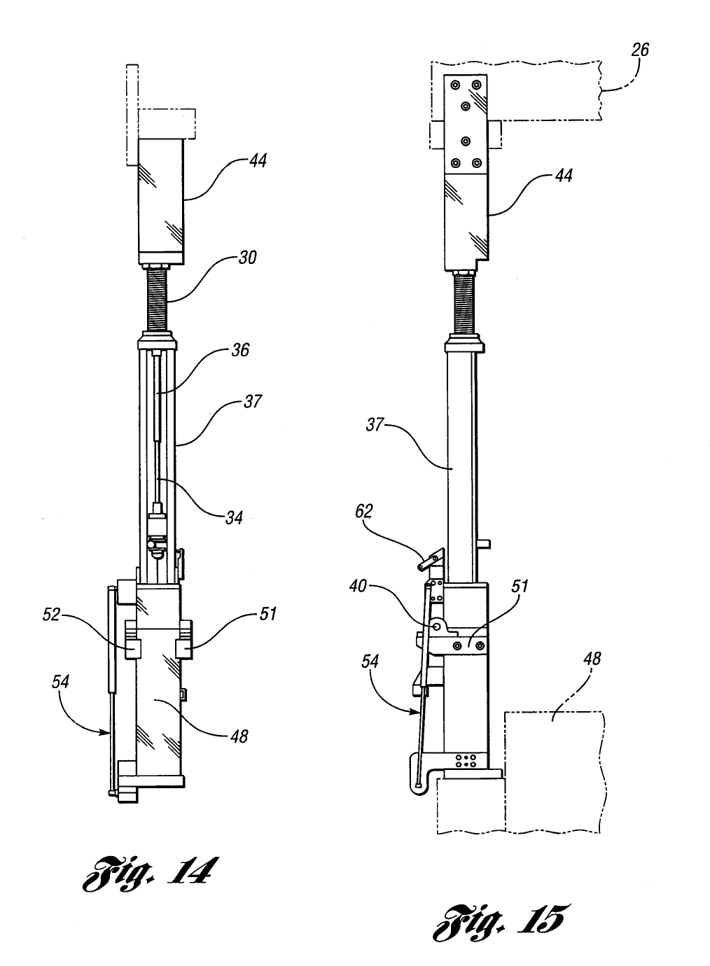

FIG. 14 is a view of the structure seen in FIG. 13, but which is illustrated from a different side view perspective.

FIG. 15 is a side view of a structure illustrated in FIGS. 12-14.

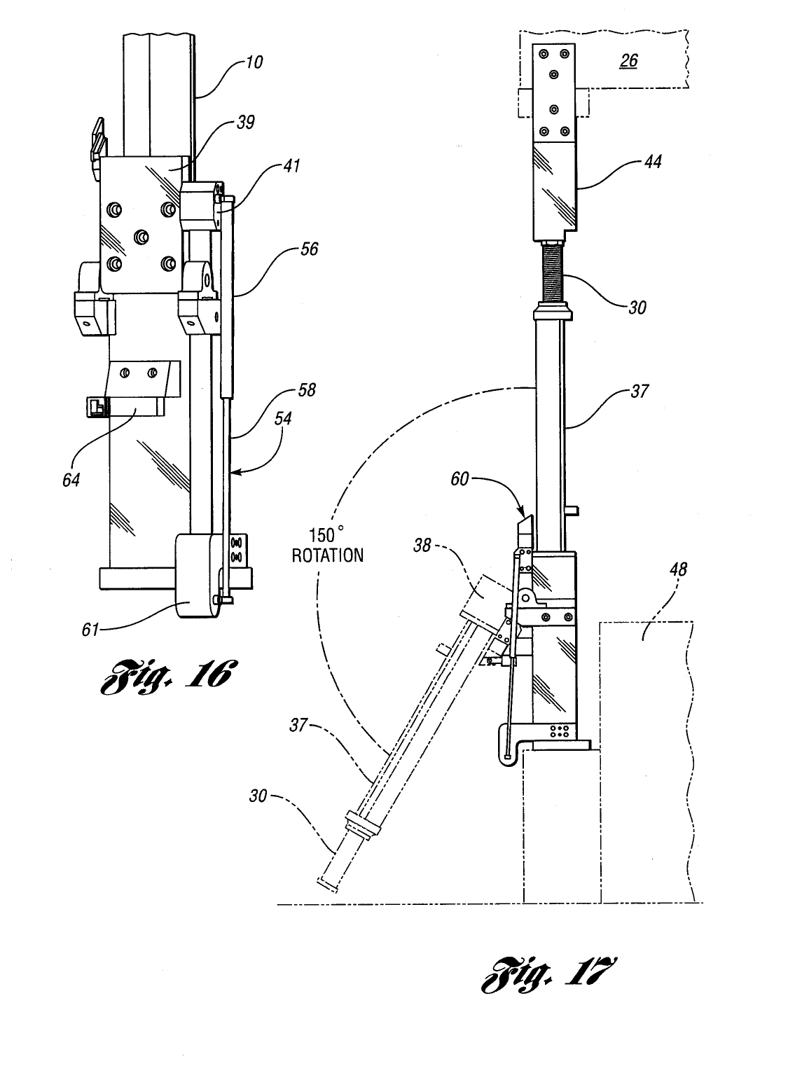

FIG. 16 is an enlarged view of the lower portion of the stop block assembly of the invention, which is seen in the assembly view of FIG. 16.

Switch actuator 60 in FIG. 11 corresponds to switch actuator 19 in FIG. 2. It carries a trigger or key 62, which registers with an opening in witch 64, seen in FIG. 16. When the stop block assembly is in the inactive position seen in FIG. 17 in phantom lines, the key 62 enters the opening in the switch 64. Switch 64 in FIG. 16 corresponds to switch 20 in FIG. 2. When the key enters the opening, the switch is closed, thereby providing power delivery to the ram motor. When the key is moved out of the switch opening, power to the motor is cut off. FIG. 2 does not illustrate a corresponding key, but a key corresponding to key 62 is used in the switch 20 of FIG. 2. It is not illustrated to simplify the view.

FIG. 17 shows the extent of arcuate movement of the stop block assembly as it is adjusted by the operator to an inactive position from the upright position. The switch 64 is closed when the stop block assembly 37 is moved to the lowered position, thereby supplying power to the ram. The displacement of the stop block assembly 37 about its pivot point through an arcuate travel distance of about 150°, for example, can occur with minimal effort by the stamping press operator. Further, there is no need to disengage cables or electric power lines or pneumatic pressure lines during operation of the stamping press in a given operating cycle. This reduces both cycle time and increases operator safety.

When the ram is raised, the operator may activate the motor 32 to cause the adjustment screw to move to the surface of the ram. This may occur after repeated forming cycles. The operator then may carry out necessary die changes or make other adjustments with complete safety. When the die changes are complete, the stop lock assembly is returned to its lowered position under the control of the air spring.

To dampen the travel of the stop lock assembly to its vertical position, a damper element or flexible bumper, seen in FIG. 2 at 15, may be used to soften the engagement of portion 16 against the top of the bolster portion 14. A similar damper element may be used with portion 38, seen in FIG. 7, although it is not illustrated in FIG. 7 for simplicity.

Although particular embodiments of the invention have been disclosed, it will be apparent that modifications may be made to the invention without departing from the scope of the invention. All such modifications and equivalents thereof are intended to be covered by the following claims.

What is claimed is:

1. A press lock-out assembly for a press for forming malleable workpieces comprising a press ram adapted to carry a first die part of a die set and a bolster adapted to carry a second die part of a die set;
the lock out assembly comprising an elongated stop block having a pivotal connection to the bolster for arcuate movement between a generally vertical position and a lowered stop block position;
the stop block being in a path of movement of the ram when the ram is retracted from a lowered ram position in which the workpiece is formed to an upper ram position;
a switch in a ram motor power circuit for controlling movement of the ram;
the pivotal connection being adapted to accommodate arcuate movement of the stop block by an operator out of the path of movement of the ram before the ram is lowered; and
a switch actuator carried by the stop block, the actuator being positioned on the stop block to engage the switch whereby power delivery to the ram is controlled to permit movement of the ram to a lowered ram position only when the stop block is in its lowered stop block position.

2. A press lock-out assembly for a press for forming malleable workpieces comprising a press ram adapted to carry a first die part of a die set and a bolster adapted to carry a second die part of a die set;
the lock out assembly comprising an elongated stop block having a pivotal connection for arcuate movement on the bolster for movement between a generally vertical position and a lowered position;
the stop block assembly being in a path of movement of the ram when the ram is retracted from a lowered ram position in which the workpiece is formed to an upper ram position;
the pivotal connection being adapted to accommodate arcuate movement of the stop block by an operator out of the path of movement of the ram when the ram is lowered,
a switch on the stop block for controlling power distribution to a ram motor to control movement of the ram; and
a switch trigger on the stop block adapted to register with the switch whereby power is delivered to the ram motor when the operator retracts the stop block from its generally vertical position to its lowered position.

3. The press lock-out assembly set forth in claim 1 wherein the stop block includes a first threaded portion and a second threaded portion that are threadably connected to accommodate changes in the effective length of the stop block, one end of one stop block portion being adapted to engage the ram when the stop block is in its generally vertical position whereby operator safety is assured as the switch is opened.

4. The lock-out assembly set forth in claim 3 wherein the stop block comprises a length adjusting motor to rotate the first threadably-connected portion relative to the second threadably-connected portion whereby the effective length of the stop block may be changed when the ram is in its upper position.

5. A press lock-out assembly for a press for forming malleable workpieces comprising a press ram adapted to carry a first die part of a die set and a bolster adapted to carry a second die part of a die set;
the lock out assembly comprising an elongated stop block having a pivotal connection for arcuate movement on the bolster for movement between a generally vertical position and a lowered position;
the stop block assembly being in a path of movement of the ram when the ram is retracted from a lowered ram position in which the workpiece is formed to an upper ram position;
the pivotal connection being adapted to accommodate arcuate movement of the stop block by an operator out of the path of movement of the ram when the ram is lowered;
a ram modification on one lateral side of the ram, the stop block being aligned with the ram modification whereby an operator may work on the die set without interference by the stop block when the ram is retracted to its upper position;
the stop block including a first portion and a second portion that are threadably connected to accommodate changes in the effective length of the stop block, one end of one stop block portion being adapted to engage the ram modification when the stop block is in its generally vertical position whereby operator safety is assured.

6. A press lock-out assembly for a press for forming malleable workpieces comprising a press ram adapted to carry a first die part of a die set, and a bolster adapted to carry a second die part of a die set;
the lock out assembly comprising an elongated stop block having a pivotal connection for arcuate movement on the bolster for movement between a generally vertical position and a lowered position;
the stop block being in a path of movement of the ram when the ram is retracted from a lowered position in which the workpiece is formed to an upper position;
the pivotal connection being adapted to accommodate arcuate movement of the stop block by an operator out of the path of movement of the ram as the ram is lowered,
a switch for controlling power distribution to a ram motor to control movement of the ram; and
a switch trigger carried by one of the stop block and the bolster whereby power delivery to the ram motor is interrupted when the operator moves the stop block from its lowered position to its generally vertical position;
the stop block assembly including a first portion and a second portion that are threadably connected together to accommodate changes in the effective length of the stop block, one end of one stop block portion being adapted to engage the ram when the stop block is in its generally vertical position whereby operator safety is assured.

7. The lock-out assembly set forth in claim 1 wherein the stop block includes an air spring having relatively movable damper elements, one damper element being carried by the stop block and the other damper element being fixed whereby manual force required to pivot the stop block is reduced.

8. The lock-out assembly set forth in claim 2 wherein the stop block includes a motion damper having relatively movable damper elements, one damper element being carried by the stop block and the other damper element being fixed whereby manual force required to pivot the stop block is reduced and its pivotal motion is cushioned at an end of its pivotal motion.

9. The lock-out assembly set forth in claim 1 wherein the stop block includes a flexible bumper between the bolster and the stop block when the stop block assumes its vertical position whereby movement of the stop block to its vertical position is cushioned.
